(19) United States
(12) Patent Application Publication
(10) Pub. No.: US 2021/0295826 A1
(43) Pub. Date: Sep. 23, 2021

(54) REAL-TIME CONCURRENT VOICE AND TEXT BASED COMMUNICATIONS

(71) Applicant: Avaya Management L.P., Santa Clara, CA (US)

(72) Inventors: Erez Morabia, Holon (IL); Gilad Levi, Yavne (IL); Tamar Goldschmidt, Modiin (IL); Oren Weitz, Ramat Hasharon (IL)

(21) Appl. No.: 16/825,829

(22) Filed: Mar. 20, 2020

(51) Int. Cl. G10L 15/10; G10L 15/30; G10L 15/22; G10L 15/06; H04L 12/18

(52) U.S. Cl. CPC G10L 15/10; G10L 15/30; G10L 2015/0635; G10L 15/063; H04L 12/18; G10L 15/22

(57) ABSTRACT

In many situations, a user speaking during an electronic conference may be difficult to understand by listeners of the conference. This may be due to a particular accent present in the speech of the speaking user. Transcription services may be automatically triggered if the speaker is not being understood by the listener, such as by the listener stating, “Can you repeat that?” or “I did not understand what you said.” Additionally, such the difficulties in understanding may be utilized to create or update a profile for the listener (e.g., difficulty understanding users with a particular accent'). As further option profiles may be updated for a category of users (e.g., listeners from Spain usually understand Portuguese accents). As a result, a transcription service may be defaulted to “off” so that resources are conserved, but automatically initiated when necessary to promote understanding for all participants in an electronic conference.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

The invention relates generally to systems and methods for electronic communications and particularly to machine-based determination and insertion of supplemental content.

### BACKGROUND

Electronic communications, such as telephone calls, conference sessions, etc. are common occurrence. Such communications allow individuals separated by small or great distances to communicate in real-time. As a result, participants in a communication may have dissimilar speaking patterns from other participants that may result in obstacles to comprehension and otherwise impair the efficiency and/or efficacy of a communication.

One particular problem that often occurs results when the participants have a particular pattern of speech, such as an accent (e.g., Irish accent, Indian accent, Australian accent, etc.) that other participants are not suitably accustom. These accents may be an obstacle to understanding for others engaged in the conference.

### SUMMARY

System and methods are provided for automatically determining a need for a transcription application and then activating/launching the transcription application.

In one embodiment, a processor(s) configured with instructions (e.g., machine-executable algorithm, artificial intelligence (AI), etc.) monitors a communication session. Based on a sensed difficult, the processor automatically generates, or causes the automatic generation of, a transcript of the spoken content of the communication session, which may be performed in real-time and the transcription may be included in the communication session. The processor may monitor various parameters of each participant. For example, the processor can use location (e.g., that the participants are in different locations (e.g., India and the U.S.) that natively have different languages), a user profile, (e.g., one that has a fluency in a particular language different from at least one other user), word matching (e.g., how many words can actually be translated into the common language being used), spoken phrases (e.g., “I did not understand that”), dialects spoken in a particular location, language difficulty profiles between a native speaker versus a non-native speaker in a specific country, a participant's native language, and/or other differences that determine an actual or likely opportunity for one speaker to not be understood by at least one other participant in the communication session—even when all participants are speaking the same language.

Once the processor determines a need to generate a transcript, the generation of the transcript is variously embodied. In one embodiment, the transcript is generated and sent for presentation to all of the participants on an associated communication device. In another embodiment, the transcript may only be sent to a subset of participants, such as specific participants or to a designated individual. For example, based on a number of participants in a specific location (e.g., in the U.S. who are native English speakers), the transcript of the participants who are native Indian speakers in India who are speaking English may be only sent to the U.S. participants or to an individual U.S. participant (e.g., one that indicates a lack of understanding more than a threshold number of times). The threshold may be static or dynamic (e.g., more than three times per half-hour, more than other participants, more than other participants within a particular location or having other common attributes, etc.). Alternatively, if one of the participants in the U.S. is a native speaking Indian, the transcript may be sent to each U.S. participant with the exception of the native speaking Indian in the U.S.

In another embodiment, the processor may continually refine or “learn” over time the participants or participant attributes where understanding is likely to be difficult. Based on the initial or subsequent training, the processor then automatically determines if a transcript is needed and by whom. Then, the processor automatically generates the transcript and provides it to a communication device associated with the identified participants. The transcript may be delivered within the video of an audio-video conference and/or as a separate text channel for presentation by a discrete (e.g., text only application) or unified communication device (e.g., a conference application).

In a further embodiment, the recipient of a transcript may be determined, in a whole or part, from a user-defined profile. For example, a user may define that he/she wants to receive a transcript of a particular individual who he/she has a difficult time understanding. Additionally or alternatively, the processor may create and/or modify a profile for a user automatically. For example, a user that frequently indicates a lack of understanding of what was said for speakers with a certain accent, speakers who have any accent except for certain accents, etc. may be automatically provided to the user's profile.

These and other needs are addressed by the various embodiments and configurations of the present invention. The present invention can provide a number of advantages depending on the particular configuration. These and other advantages will be apparent from the disclosure of the invention(s) contained herein.

In one embodiment, a system is disclosed, comprising: a network interface to a network; a processor; and wherein the processor performs: broadcasting, via a network interface, a conference content to a plurality of communication devices; receiving, via the network interface, a conference input from a first communication device of the plurality of communication devices, wherein the conference input comprises an audio input with speech encoded therein and further incorporating the conference input into the conference content, and wherein the speech comprises a first speech pattern of a first user associated with the first communication device; upon determining that a second user, associated with a second communication device of the plurality of communication devices, is unable to understand at least a portion of the speech having the first speech pattern, transcribing the speech; and broadcasting the transcribed speech to the second communication device.

In another embodiment, a method is disclosed, comprising: broadcasting, via a network interface, a conference content to a plurality of communication devices; receiving, via the network interface, a conference input from a first communication device of the plurality of communication devices, wherein the conference input comprises an audio input with speech encoded therein and further incorporating the conference input into the conference content, and wherein the speech comprises a first speech pattern of a first user associated with the first communication device; upon determining that a second user, associated with a second communication device of the plurality of communication devices, is unable to understand at least a portion of the speech having the first speech pattern, transcribing the speech; and broadcasting the transcribed speech to the second communication device.

In another embodiment, a system is disclosed comprising: means for broadcasting, via a network interface, a conference content to a plurality of communication devices; means for receiving, via the network interface, a conference input from a first communication device of the plurality of communication devices, wherein the conference input comprises an audio input with speech encoded therein and further incorporating the conference input into the conference content, and wherein the speech comprises a first speech pattern of a first user associated with the first communication device; means for, upon determining that a second user, associated with a second communication device of the plurality of communication devices, is unable to understand at least a portion of the speech having the first speech pattern, transcribing the speech; and means for broadcasting the transcribed speech to the second communication device.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware , an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a first data structure in accordance with embodiments of the present disclosure;

FIG. 3 depicts a second data structure in accordance with embodiments of the present disclosure;

FIG. 4 depicts a third data structure in accordance with embodiments of the present disclosure;

FIG. 5 depicts a process in accordance with embodiments of the present disclosure; and

FIG. 6 depicts a second system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

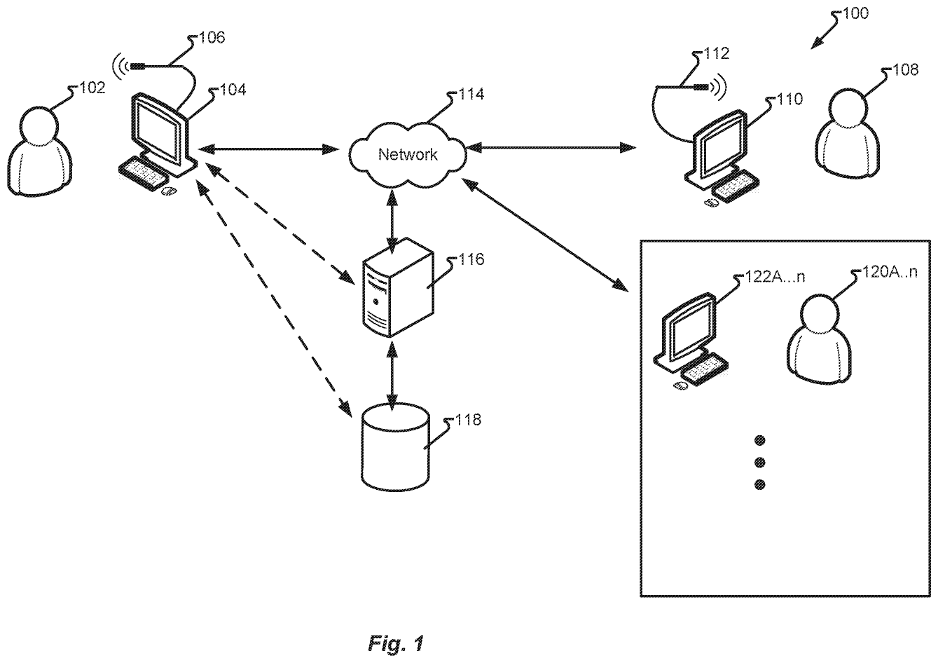

FIG. 1 depicts system 100 in accordance with embodiments of the present disclosure. Generally, and in one embodiment, user 102 is conducting an electronic communication, via communication device 104, with user 108 via communication device 110 utilizing network 114. The electronic communication comprises, at least, voice from one of user 102 or user 108 as encoded into an audio signal and transported via network 114. The electronic communication may provide audio from both user 102 and user 108, such as by capturing speech by microphone 106 and microphone 112, respective, encoding the speech for conveyance over network 114. Additionally, the electronic conference may comprise video, documents, still images, co-browsing, and/or other content. As a further option additional users 120A-n may participate utilizing an associated additional communication devices 122A-n communicating via network 114. The electronic conference is referred to herein more simply just as a “conference.”

The conference may utilize server 116 to facilitate conferencing services, such as managing agendas, adding/dropping users, floor control, transcription services, broadcasting conference content, receiving inputs to the conference content, and/or other conferencing services. Optionally, server 116 may be, or be integrated with one of the communication devices, such as communication device 104, engaged in the conference. Server 116 may comprise and/or utilize one or more microprocessors, cores, blades, servers, shared or distributed processors (e.g., array, “cloud,” “farm,” etc.), other processing devices or appliances, or any combination of two or more of the foregoing, collectively referred to herein as a “processor.”

Each of communication device 104, communication device 110, additional communication devices 122A-n comprises its own processor, which may be combined with the processor of server 116 or discrete therefrom. Each of communication device 104, communication device 110, additional communication devices 122A-n comprises a network interface (e.g., network interface card/chip, port, wired/wireless network communication interface, etc.) to enable communication via network 114. Other devices and/or features may also be provided, including but not limited to, microphone, speakers, display, camera, keyboard, mouse, printer, and/or other input-output component(s).

Data utilized in system 100 may be maintained, at least in part, in data storage 118 which may be a component of server 116 (which itself may be integrated with communication device 104). Data storage 118 comprises a non-transitory storage device. Additionally or alternatively, data storage 118 may comprise one or more other storage devices, including but not limited to, network attached storage, internal storage device, external storage device, solid state memory, on-board memory, on-chip memory, cache, access to an external storage device(s) (e.g., “cloud” storage devices, etc.) and/or combinations of any two or more of the foregoing or other non-transitory storage devices operable to maintain data accessible to the processor of server 116.

In one embodiment, user 102 is speaking. The speech is picked up by microphone 106 and encoded by communication device 104. Server 116 incorporates the encoded speech into the conference content and broadcasts the conference content to all participating devices, including communication device 110 and optionally additional communication devices 122A-n. Communication device 110 decodes the audio and presents the decoded audio as sound presented by speakers (e.g., headphones, integrated speakers, networked speakers, etc.) to enable user 108 to hear the speech provided by user 102. Optionally, one or more of additional users 120A-n, via their respective additional communication devices 122A-n, may similarly hear the speech provided by user 102 as, at least a portion of, the conference content.

User 102 may speak with a particular speech pattern, generally recognized as a dialect or accent (herein, “accent”). Accents may affect the emphasis on certain portions of a word, intonations (e.g., more/less nasal), truncation or concatenation of sounds of words (e.g., pronouncing “car” as “cah,” or adding an “r” to a word, as in pronouncing “window” as “winder”), or the delineation of syllable breaks (e.g., pronouncing “develop” as “devil-up” versus “de-vel-up” or “Hawaii” as “Ha-whyee” versus “Ha-wah-E”). As one of ordinary skill in the art may appreciate, other differences may be associated with an accents, within a common spoken language, and utilized herein without departing from the scope of the embodiments.

If user 108 is having a difficult time understanding the speech of user 102 due to an accent of user 102, user 108 may waste time having user 102 repeat themselves or merely disregard the information in the missed speech. As a result, understanding and the consequences of not understanding may result in wasted time and other resources and/or errors caused by miscommunications and/or non-communications.

In another embodiment, upon determining that user 108 is having difficulty understanding user 102, server 116 may initiate, without human input, a transcription service to transcribe the speech of user 102. The transcription service may be executed by server 116 and/or communication device 104 and the text of the transcript provided to server 116. The transcript may then be provided as text integrated into a video portion of the conference content or as content of a separate text stream provided by a text communication channel, which may be discrete from the conference content and established between server 116 and communication device 110 for presentation by communication device 110. In a further embodiment, accent may be more personal, such as speech impediment that may cause the speech provided by user 102 to be more difficult to understand. Accordingly, in one embodiment, a speech pattern may be equivalent to accent, as defined herein, and, in another embodiment, speech pattern may comprise accent as well as other characteristics of speech expressed by an individual or category of individuals. The transcription services may be a non-specific transcription services or one that has been seeded with specific words or phrases indicative of either user 102, specifically, or a category of individuals having an accent of which user 102 is a member of that group.

Accents may form in a user due to significant exposure, such as residency, in a particular area having a particular accent when young commonly causes individuals to have a shared accent. Accordingly, if user 108 has a difficult time understanding user 102, having a particular accent, then user 108 will likely have a difficult time understanding a category of users of which user 102 is a member. When user 108 participates in a conference, data storage 118 may determine that transcription is necessary based on the speaker being a member of the category. This may also occur when the speaking participant changes. For example, additional user 120B, when a member of a category of users for which communication device 110 has a difficult time understanding, may automatically initiate the transcription, even if the previous speaker did not cause transcription to occur. Once transcription has been initiated, it may be maintained until the conference terminates or sooner, such as when the current speaker changes.

In another embodiment, server 116 may update a record associated with accents of which a particular user has difficulty understanding, accents that a particular category of speakers have difficulty understanding or being understood, or an association of attributes (such as national or regional origin) and associated attributes that are/are not difficult to understand. Accordingly, server 116 may execute as an artificial intelligence (AI) engine and self-learn which users and/or category of users should have transcription turn on or a threshold of understanding that may be adjusted under the assumption that a particular speaker-listener combination (e.g., speaking user 102 and listening user 108) is likely problematic or likely not problematic. For example, one request to have the speaker repeat something may be determined to be a “one off” if the speaker-listener, or their categories, indicate a good level of understanding and, therefore, transcription not imitated. If there are subsequent instances of indications that the listener did not understand the speaker, then transcription may be automatically initiated. However, if server 116 has determined that attributes of the speaker-listener, or the categories, indicate a difficulty to understanding, transcription may be initiated before the speaker speaks or at a lower threshold, such as the first occurrence of an indication of lack of understanding (e.g., “Can you repeat that?”, “I didn't understand what you said, etc.).

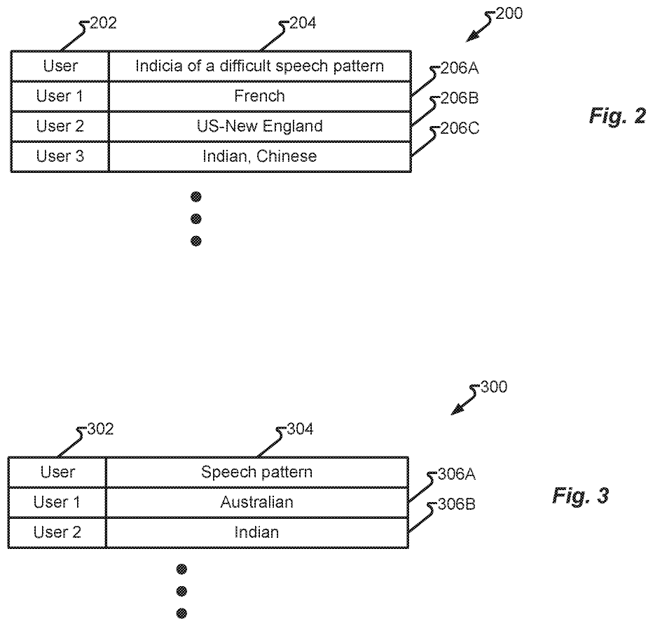

FIG. 2 depicts data structure 200 in accordance with embodiments of the present disclosure. In one embodiment, data structure 200, or a portion thereof, may be accessed by a processor of server 116, such as to determine when a particular user will likely have difficulty understanding a speaker on a conference. Data structure 200 may comprise user fields 202 and associated identifiers or indicia of speech patterns that have been determined to cause difficulty in understanding. Accordingly, a number of records, such as records 206, of which more or fewer records 206 may exist, may be maintained in data storage 118. For example, in record 206B, field 202 indicates that “User 2” has difficulty understanding those with a New England accent, as indicated by the indicia of speech pattern “US-New England” in field 204. In other embodiments, a degree of match may be utilized in or as a supplement to data structure 200. For example, “User 3” may have a degree, such as a ‘1 out of 10’ difficulty score understanding speakers with an Indian accent and a ‘8 out of 10’ difficulty score understanding speakers with a Chinese accent. As a result, the threshold for server 116 to initiate automatic transcription of the speaker may be higher for Indian speakers, as understanding is likely to be good in most circumstances, but server 116 may automatically start transcription at a lower threshold, such as the first indication of a lack of understanding for Chinese speakers.

FIG. 3 depicts data structure 300 in accordance with embodiments of the present disclosure. In one embodiment, data structure 300 provides a speech pattern of individual users and/or categories of users. As one of ordinary skill in the art can appreciate, the pattern of speech and the ability to understand that pattern of speech are closely related or identical. For example, a person speaking English with a brogue will likely understand, or at least not have an absence of understanding due to the brogue, from speech provided by another English speaker with a brogue.

Accordingly, in one embodiment, data structure 300 comprises field 302 for user identification to identify a user or category of users and field 304 providing indicia of the user's speech pattern in a number of records 306. For example, “user 2” in field 302 has indicia of speech patter of “Indian” in field 304 for record 306B. In other embodiments, a degree of match may be utilized in or as a supplement to data structure 300. For example, another user (not shown) may have a strong accent or a weak accent and, as result, field 304 may have a scale or other relative value of the indicia of the speech pattern. As a result, server 116 may consider the degree of match, such that if “User 3” (see FIG. 2) has difficulty understanding speakers with an Indian accent but the value in field 304 provides a low relative value of the accent for “User 2” then the threshold to initiate transcription may be low. In contrast, if the value is high, transcription may automatically begin sooner or even before a conference starts as the potential for not understanding or misunderstanding will be higher.

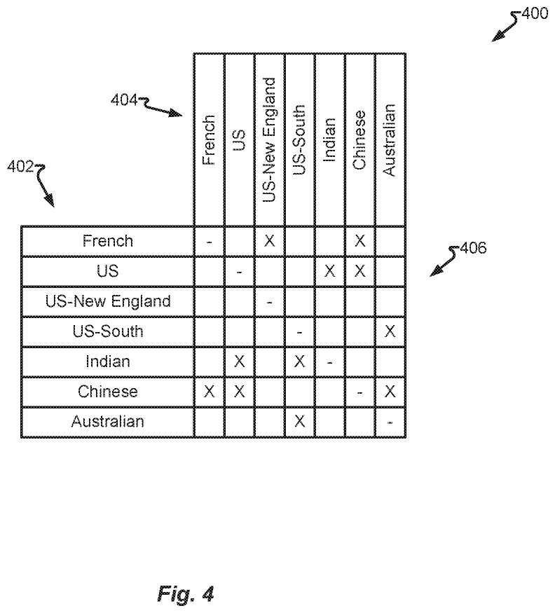

FIG. 4 depicts structure 400 in accordance with embodiments of the present disclosure. In one embodiment, relationships between groups may be determined as to who has difficulty or a degree of difficulty understanding the speech patterns of another group. Accordingly, data structure 400 illustrates an array of speaker groups 402 and listening groups 404 and array 406 comprising cells where ones of the speaker groups 402 intersect with ones of the listening groups 404.

In another embodiment, server 116 may create and/or update any entry in array 406. For example, if a speaker in speaker group 402 is French and a listener in listening group 404 is from “US-South” and having difficulty understanding, then the corresponding cell in array 406 may be incremented. With sufficient incrementations, a particular intersection may be determined to have difficulty and cause server 116 to initiate transcription sooner than if fewer incidents (e.g., fewer instances of incrementation) had occurred.

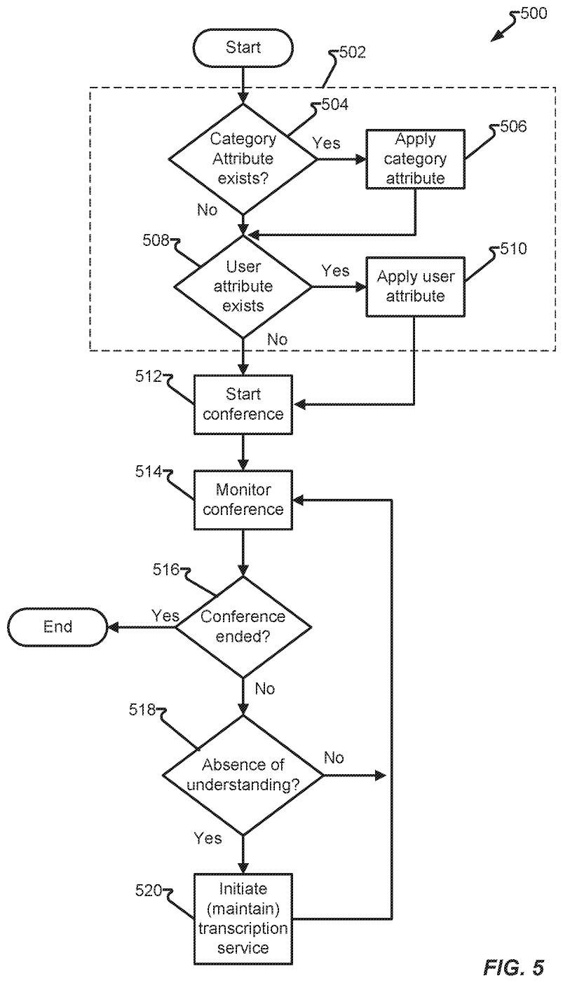

FIG. 5 depicts process 500 in accordance with embodiments of the present disclosure. In one embodiment, process 500 may be implemented as machine-executable instructions for execution by a processor of server 116. Process 50 begins and optional block 502 may be executed as an optional implementation. If optional block 502 is not implemented, process 500 may being at step 512. If optional block 502 is implemented, then one or more of the decision-process step pairs are implemented. One decision-process step pair is provided by test 504 and step 506 and another decision-process step pair is provided by test 508 and step 510 one or both of which may be executed when optional block 502 is utilized. Test 504 determines if a category attribute exists. For example, user 108 may be a member of the listening group “Australian” and have difficulty understanding speakers that are in the speaking group of “Chinese” (see FIG. 4), accordingly, step 506 may apply a category attribute or indicia whereby speakers/listeners having difficulty or degree of difficulty greater than a previously determined threshold, may more readily cause transcription to be automatically initiated. Similarly, test 508 may determine if a particular user has difficulty with speakers having an indicia of a particular speaking pattern (see, FIG. 3) and, if so, more readily initiate transcription.

Step 512 initiates the conference or receives a signal indicating that the conference has begun. Step 514 monitors the conference, such as by a speech recognition process executed by a processor of server 116. However, if test 516 indicates the conference has ended then process 500 may terminate, otherwise processing continues to test 518 to determine if an absence of understanding is present, such as by the determination that the monitored conference (step 514) comprises an indication of such an absence of understanding. For example, a speaker, such as user 102 may be providing speech to the conference and be interrupted by speech, text, and/or other indication that user 108 did not understand what was said by user 102. Accordingly, test 518 may be determined in the affirmative. Optionally, test 518 may evaluate the degree or frequency of such an indication of an absence of understanding based on one or more of a listening user's indicia of difficulty in understanding (see, FIG. 2), a speaking user's indicia of speech pattern (see, FIG. 3), the association of groups comprising the speaking user and listening user (see, FIG. 4), a frequency of occurrence of two or more such indications (e.g., three instances of “Can you repeat that?” within three minutes, or other previously determined threshold, versus the same three instances over an hour, or other previously determined threshold), or the occurrence or number of occurrences and their relationship to when the speaking user began to speak (for example, “I did not understand you.” when occurring within the first few seconds, or other previously determined threshold, may indicate a high likelihood of subsequent difficulty in understanding, versus the same instance occurring after the speaker had been talking for twenty minutes, or other previously determined threshold.). If test 518 is determined in the negative, processing may loop back to step 514 otherwise processing continues to step 520.

Step 520 initiates, or maintains if already initiated, a transcription service. Such as by executing a transcription service by a processor of server 116 or by signaling a communication device of the speaking user to provide a transcription to server 116 which is then provided to the listening user having difficulty. In another embodiment, all listening users are provided with the transcription. In yet another embodiment, the text is provided directly from the speaking user's communication device to the listening user's communication device, such as by causing a Session Initiation Protocol (SIP) session to be initiated therebetween and wherein the media in the media exchange portion of the SIP session comprises the text from the transcription. Similarly, server 116 may overlay the text of the transcript onto the video of the conference content provided to the listening user's communication device, and optionally the communication devices of all users, or establish a discrete data channel with the listening user receiving the text via the newly established channel that is separate from the channel utilized to convey the conference content or receive conference inputs. Optionally, step 520 may discontinue transcription and conserve resources, such as by a different user becoming the speaking user.

In another embodiment, step 520 further updates indicia of speech patterns associated with a difficulty in understanding automatically and without human intervention. For example, step 520 may initiate transcription as a result of an indication of an absence of understanding and further update data structure 200 (see, FIG. 2) and/or data structure 400 (see, FIG. 4) to indicate or increment indicia of difficulty understanding for the listening user's attributes associated with the particular speaker (e.g., FIG. 2) or for a group (e.g., FIG. 4).

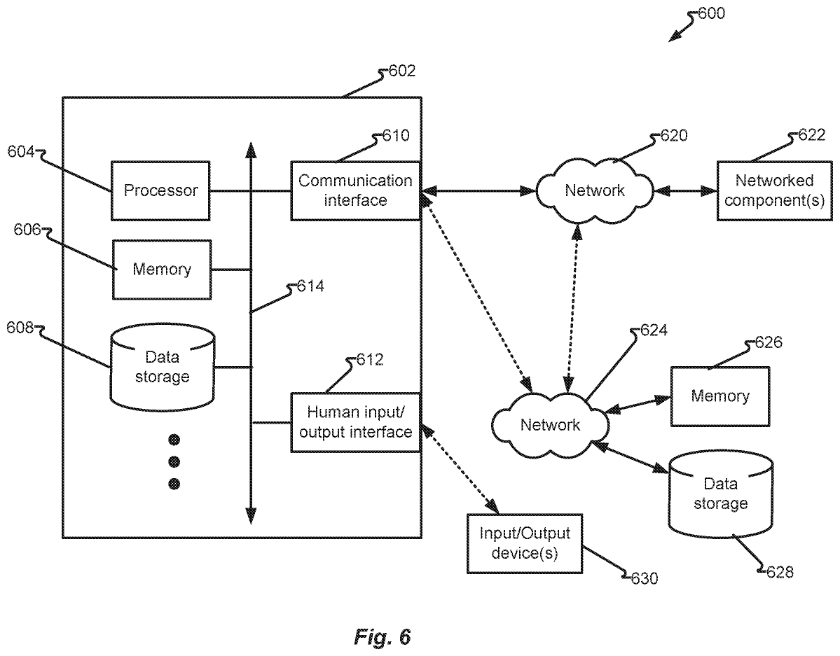

FIG. 6 depicts system 600 in accordance with embodiments of the present disclosure.

In one embodiment, communication device 104, communication device 110, and/or server 116 may be embodied, in whole or in part, as device 602 comprising various components and connections to other components and/or systems. The components are variously embodied and may comprise processor 604. Processor 604 may be embodied as a single electronic microprocessor or multiprocessor device (e.g., multicore) having therein components such as control unit(s), input/output unit(s), arithmetic logic unit(s), register(s), primary memory, and/or other components that access information (e.g., data, instructions, etc.), such as received via bus 614, executes instructions, and outputs data, again such as via bus 614.

In addition to the components of processor 604, device 602 may utilize memory 606 and/or data storage 608 for the storage of accessible data, such as instructions, values, etc. Communication interface 610 facilitates communication with components, such as processor 604 via bus 614 with components not accessible via bus 614. Communication interface 610 may be embodied as a network port, card, cable, or other configured hardware device. Additionally or alternatively, human input/output interface 612 connects to one or more interface components to receive and/or present information (e.g., instructions, data, values, etc.) to and/or from a human and/or electronic device. Examples of input/output devices 630 that may be connected to input/output interface include, but are not limited to, keyboard, mouse, trackball, printers, displays, sensor, switch, relay, etc. In another embodiment, communication interface 610 may comprise, or be comprised by, human input/output interface 612. Communication interface 610 may be configured to communicate directly with a networked component or utilize one or more networks, such as network 620 and/or network 624.

Network 114 may be embodied, in whole or in part, as network 620. Network 620 may be a wired network (e.g., Ethernet), wireless (e.g., WiFi, Bluetooth, cellular, etc.) network, or combination thereof and enable device 602 to communicate with network component(s) 622.

Additionally or alternatively, one or more other networks may be utilized. For example, network 624 may represent a second network, which may facilitate communication with components utilized by device 602. For example, network 624 may be an internal network to contact center #02 whereby components are trusted (or at least more so) that networked components 622, which may be connected to network 620 comprising a public network (e.g., Internet) that may not be as trusted. Components attached to network 624 may include memory 626, data storage 628, input/output device(s) 630, and/or other components that may be accessible to processor 604. For example, memory 626 and/or data storage 628 may supplement or supplant memory 606 and/or data storage 608 entirely or for a particular task or purpose. For example, memory 626 and/or data storage 628 may be an external data repository (e.g., server farm, array, “cloud,” etc.) and allow device 602, and/or other devices, to access data thereon. Similarly, input/output device(s) 630 may be accessed by processor 604 via human input/output interface 612 and/or via communication interface 610 either directly, via network 624, via network 620 alone (not shown), or via networks 624 and 620.

It should be appreciated that computer readable data may be sent, received, stored, processed, and presented by a variety of components. It should also be appreciated that components illustrated may control other components, whether illustrated herein or otherwise. For example, one input/output device 630 may be a router, switch, port, or other communication component such that a particular output of processor 604 enables (or disables) input/output device 630, which may be associated with network 620 and/or network 624, to allow (or disallow) communications between two or more nodes on network 620 and/or network 624. Ones of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices.

This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system, comprising:
a network interface to a network;
a processor; and
wherein the processor performs:
broadcasting, via a network interface, a conference content to a plurality of communication devices;
receiving, via the network interface, a conference input from a first communication device of the plurality of communication devices, wherein the conference input comprises an audio input with speech encoded therein and further incorporating the conference input into the conference content, and wherein the speech comprises a first speech pattern of a first user associated with the first communication device;
upon determining that a second user, associated with a second communication device of the plurality of communication devices, is unable to understand at least a portion of the speech having the first speech pattern, transcribing the speech; and
broadcasting the transcribed speech to the second communication device.

2. The system of claim 1, further comprising:
a data storage comprising a non-transitory data storage device; and
wherein the processor further preforms:
accessing a first data record from the data storage, wherein the first data record comprises an indicia of a difficult speech pattern for the second user; and
wherein determining that the second user is unable to understand at least a portion of the speech due to the first speech pattern of the first user further comprises, determining that the indicia of difficult speech pattern matches an indicia of the first speech pattern identifying the first speech pattern.

3. The system of claim 2, wherein the processor further performs:
monitoring the conference input of the second user for one or more words indicating an absence of understanding of the speech; and
upon determining the one or more words indicating an absence of understanding are present, updating the first data record to cause the difficult speech pattern to comprise the indicia of the first speech pattern.

4. The system of claim 3, wherein the processor performs updating the first data record to cause the difficult speech pattern to comprise the indicia of the first speech pattern, comprising updating a third data record, in the data storage, to cause a default difficult speech pattern to be associated between a first category of users comprising the first user and a second category of users comprising the second user.

5. The system of claim 3, wherein the indicia of the first speech pattern comprises one or more of current geographic location of residence of the first user or a historic geographic location of residence of the first user.

6. The system of claim 2, further comprising:
the processor performing accessing a second data record from the data storage, wherein the second data record comprises an indicia of a second speech pattern identifying a second speech pattern of the second user; and
the processor performing accessing a third data record from the data storage, wherein the third data record comprises an association between the indicia of the first speech pattern and the indicia of the second speech pattern; and
wherein the determining that the second user is unable to understand at least a portion of the speech having the first speech pattern upon determining the association between the indicia of the first speech pattern and the indicia of the second speech pattern indicates the difficult speech pattern.

7. The system of claim 1, wherein the processor further performs, upon determining that the speech no longer comprises the speech pattern of the first user, discontinuing transcribing speech and broadcasting the transcribed speech.

8. The system of claim 1, wherein the processor performs transcribing the speech by signaling the first communication endpoint to execute a transcription service and provide the output therefrom, as the transcribed speech, to the processor.

9. The system of claim 1, wherein the processor performs broadcasting the transcribed speech to the second communication device further comprising, broadcasting the transcribed speech to at least one additional communication devices of the plurality of communication devices.

10. The system of claim 1, wherein the processor broadcasts the transcribed speech to the second communication device, comprising establishing a separate text channel of communications with the second communication device and broadcasts the transcribed speech to the second communication device via the separate text channel and wherein the conference content is broadcasts on at least one conference channel, each of which is different from the separate text channel.

11. A method, comprising:
broadcasting, via a network interface, a conference content to a plurality of communication devices;
receiving, via the network interface, a conference input from a first communication device of the plurality of communication devices, wherein the conference input comprises an audio input with speech encoded therein and further incorporating the conference input into the conference content, and wherein the speech comprises a first speech pattern of a first user associated with the first communication device;
upon determining that a second user, associated with a second communication device of the plurality of communication devices, is unable to understand at least a portion of the speech having the first speech pattern, transcribing the speech; and
broadcasting the transcribed speech to the second communication device.

12. The method of claim 11, further comprising:
accessing a first data record from a data storage, wherein the first data record comprises an indicia of a difficult speech pattern for the second user; and
wherein determining that the second user is unable to understand at least a portion of the speech due to the first speech pattern of the first user further comprises, determining that the indicia of difficult speech pattern matches an indicia of the first speech pattern identifying the first speech pattern.

13. The method of claim 12, further comprising:
monitoring the conference input of the second user for one or more words indicating an absence of understanding of the speech; and
upon determining the one or more words indicating an absence of understanding are present, updating the first data record to cause the difficult speech pattern to comprise the indicia of the first speech pattern.

14. The method of claim 13, wherein updating the first data record to cause the difficult speech pattern to comprise the indicia of the first speech pattern, comprising updating a third data record, in the data storage, to cause a default difficult speech pattern to be associated between a first category of users comprising the first user and a second category of users comprising the second user.

15. The method of claim 13, wherein the indicia of the first speech pattern comprises one or more of current geographic location of residence of the first user or a historic geographic location of residence of the first user.

16. The method of claim 12, further comprising:
accessing a second data record from the data storage, wherein the second data record comprises an indicia of a second speech pattern identifying a second speech pattern of the second user; and
accessing a third data record from the data storage, wherein the third data record comprises an association between the indicia of the first speech pattern and the indicia of the second speech pattern; and
wherein the determining that the second user is unable to understand at least a portion of the speech having the first speech pattern upon determining, the association between the indicia of the first speech pattern and the indicia of the second speech pattern indicates the difficult speech pattern.

17. The method of claim 11, further comprising, upon determining that the speech no longer comprises the speech pattern of the first user, discontinuing transcribing speech and broadcasting the transcribed speech.

18. The method of claim 11, wherein transcribing the speech comprises signaling the first communication endpoint to execute a transcription service and provide the output therefrom as the transcribed speech.

19. The method of claim 11, wherein the processor performs broadcasting the transcribed speech to the second communication device further comprising, broadcasting the transcribed speech to at least one additional communication devices of the plurality of communication devices.

20. A system comprising:
means for broadcasting, via a network interface, a conference content to a plurality of communication devices;
means for receiving, via the network interface, a conference input from a first communication device of the plurality of communication devices, wherein the conference input comprises an audio input with speech encoded therein and further incorporating the conference input into the conference content, and wherein the speech comprises a first speech pattern of a first user associated with the first communication device;
means for, upon determining that a second user, associated with a second communication device of the plurality of communication devices, is unable to understand at least a portion of the speech having the first speech pattern, transcribing the speech; and
means for broadcasting the transcribed speech to the second communication device.
